(19) United States
(12) Patent Application Publication
(10) Pub. No.: US 2007/0160840 A1
(43) Pub. Date: Jul. 12, 2007

(54) METHODS OF PREPARING CONDUCTIVE PARTICLES AND CONDUCTIVE PARTICLES PREPARED BY THE SAME

(75) Inventors: Jin Gyu Park, Seoul (KR); Jung Bae Jun, Kyeonggi-do (KR); Tae Sub Bae, Kyeonggi-do (KR); Jae Ho Lee, Kyeonggi-do (KR)

Correspondence Address: MYERS BIGEL SIBLEY & SAJOVEC, PO BOX 37428, RALEIGH, NC, 27627, US

(73) Assignee: Cheil Industries, Inc.

(21) Appl. No.: 11/616,929

(22) Filed: Dec. 28, 2006

(30) Foreign Application Priority Data
Dec. 29, 2005 (KR) 2005-0133676
Apr. 28, 2006 (KR) 2006-0038475

(51) Int. Cl. B05D 7/00; B32B 15/02

(52) U.S. Cl. 428/407; 427/212

(57) ABSTRACT

Provided herein are methods of preparing conductive particles including hydrophilizing the surface of polymer particles by a low-temperature plasma treatment; and coating the hydrophilized surface of the polymer particles with a conductive metal layer to form the conductive particles. The methods provided herein may provide desirable adhesion between the conductive metal layer and the polymer particles and may minimize the aggregation of the polymer particles during plating. As a result, methods disclosed herein may provide for conductive particles having desirable electrical conductivity and reliability.

### CLAIM OF PRIORITY

This application claims priority under 35 U.S.C. §119 to Korean Application Nos. 2005-133676 filed Dec. 29, 2005 and 2006-38475 filed on Apr. 28, 2006, the contents of which are herein incorporated by reference in their entirety.

### FIELD OF THE INVENTION

The present invention relates to methods of preparing electrically conductive particles, and more particularly, to methods of preparing conductive particles that include polymer particles.

### BACKGROUND OF THE INVENTION

Conductive resin and plastic materials are typically used in electrical connections between minute sites of electronic devices, e.g., between ITO electrodes and driving LSIs, between LSI chips and circuit boards and between micro-pattern electrode terminals in liquid crystal display (LCD) panels. Specifically, anisotropic conductive films may be used to provide suitable electrical contact between electrodes. As pitch intervals have become smaller in conductive film applications, the conductivity, adhesiveness, dispersibility and composition of conductive particles, which may impart anisotropic conductivity to the conductive films, have become increasingly important.

Some conductive particles may be prepared by forming thin metal layers on base particles, e.g., Ni particles, Ni/Au complex particles or plastic particles. The type of base particle used may depend on the particular application of the anisotropic conductive film.

Electroless plating has been employed to prepare conductive particles using plastic particles as the base particles. Such conductive resin/metal particles may be prepared by pretreating, e.g., degreasing, treatment with surfactants, etching, catalysis, treatment with reducing agents and the like, of the polymer particles or powder, followed by electroless plating (See, e.g., Japanese Patent No. 2507381, Japanese Patent Publication No. 1994-096771 and Japanese Patent Laid-open Nos. 2000-243132, 2003-064500 and 2003-068143). The electrical/physicochemical properties of the plated particles may vary according to the kind and number of metals to be introduced. Nickel/gold (Ni/Au) bilayers have been employed as metal layers for anisotropic conductive films (Japanese Patent Laid-open Nos. 1999-329060 and 2000-243132).

To successfully form a relatively thin and uniform metal layer on the surface of fine particles by electroless plating, the particle size should be relatively uniform, the particles should be sufficiently dispersible in a plating solution and particle aggregation should be minimized. As an example, when the specific gravity of polymer particles having a size of 5 μm is 1.00, the specific surface area of the polymer particles is about 1.2 m²/g and the number of the polymer particles is about 1.53×10¹⁰/g. In such a case, particle uniformity and dispersibility may be particularly important in order to ensure uniform thickness of the plating layer.

However, it may be difficult to achieve the above-mentioned properties using conventional polymeric materials. For example, Japanese Patent No. 1982152 indicates that polymer particles must be in the form of a core powder capable of binding noble metal ions, e.g., epoxy, acrylonitrile and amide resin powders, in order to sufficiently meet the above requirements. Alternatively, the base particles may be surface-treated with epoxy resins, which may be cured by amide-substituted organosilane coupling agents and/or amine curing agents. Furthermore, Japanese Patent No. 3436327 discusses a method of preparing conductive particles using benzoguanamine, which exhibits a tendency toward hydrophilization compared to styrene-based and olefin-based polymeric materials, followed by electroless plating.

Such limited selection of materials that may be suitably used as the polymer base particles in conductive particles restricts the mechanical/physical properties of the conductive particles formed after plating.

Representative methods of hydrophilizing polymer particles include radical copolymerization of hydrophilic monomers and hydrophobic monomers, and the preparation of particles using radically reactive emulsifiers having surface activity. However, where hydrophilic monomers are copolymerized with hydrophobic monomers, e.g., styrene monomers, it may be difficult to attain the suitable compressive strength and elastic restoration necessary for anisotropic conductive interconnection. It may also be difficult to maintain monodispersity of the particles, which may be important during the preparation of the particles.

More specifically, when conductive metal-coated particles are treated under heat and pressure to achieve anisotropic conductive interconnection, the use of hydrophilic monomers may be an obstacle in maintaining suitable strength, and the particles rupture from the heat and pressure applied to the conductive metal-coated particles. Such hydrophilic monomers may also not provide the necessary chemical resistance required for processing the conductive particles into film products, such as anisotropic conductive films. In addition, although hydrophilization of particles using reactive surfactants may enable maintenance of the dispersibility of the particles in plating solutions due to the presence of hydrophilic groups on the surface of the particles, adhesion at the interface between the particles and Ni may be deteriorated, which may decrease the electrical interconnection reliability of the final interconnection structure. Furthermore, since the specific gravity of the particles to be plated may increase in proportion to the amount of Ni reduced, dipping time and concentration of Ni, aggregation of the particles during plating may occur. As a consequence, there is a need for novel methods of preparing conductive particles that results in particles have desirable properties, e.g., suitable of compressive properties and prevention of aggregation during plating.

### SUMMARY OF THE INVENTION

According to some embodiments of the present invention, the surface of polymer particles may be hydrophilized by a low-temperature plasma treatment. In some embodiments, the plasma treatment may be performed in a fluidized bed reactor using a plasma gas that includes argon. Such treatment may improve the dispersibility of the polymer particles in a plating solution, may improve the plating stability of the polymer particles and may minimize aggregation of the polymer particles after plating. Furthermore, in some embodiments of the invention, methods for hydrophilizing the surface of polymer particles by plasma treatment do not change the bulk physical properties of the polymer particles.

According to some embodiments of the present invention, methods for preparing conductive particles include hydrophilizing the surface of polymer particles by a low-temperature plasma treatment, and coating the hydrophilized surface of the polymer particles with a conductive metal layer to form the conductive particles.

In some embodiments of the present invention, the hydrophilized polymer particles may be etched in order to form “anchors” on the surface of the polymer particles. In some embodiments, the etched polymer particles may be dipped in a solution including tin chloride and palladium chloride.

According to some embodiments of the present invention, the conductive metal layer may be formed by one or more of electroless plating, coating using a metal powder, vacuum evaporation, ion plating and ion sputtering.

In some embodiments of the present invention, the hydrophilization of the surface of the polymer particles may introduce one or more of peroxide and hydroxyl groups onto the surface of the polymer particles. In some embodiments, the hydrophilic groups introduced onto the surface of the polymer base particles may be present at a density in a range of about 1 to about 100 nmol/cm².

In some embodiments of the present invention, the polymer particles may have an average particle diameter in a range of about 1.0 μm to about 1,000 μm and a particle diameter distribution within about 90 to about 110% of the average particle diameter.

In some embodiments of the present invention, the conductive metal layers formed on the polymer particles may be composed of two or more metal layers, such as Ni, Ni—P, Ni—B, Au, Ag, Ti and Cu layers. In some embodiments, each of the metal layers has a thickness in a range of about 10 to about 5,000 Å. In some embodiments, the total thickness of the conductive metal layer is in a range of about 20 to about 10,000 Å.

In some embodiments of the present invention, provided are conductive particles prepared by a method according to an embodiment of the invention.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” another element or layer, it can be directly on, connected to, or coupled to the other element or layer, or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealize or overly formal sense unless expressly so defined herein.

The present invention provides methods for preparing conductive particles in which polymer particles may be treated by a low temperature plasma treatment to improve adhesion of a conductive metal layer formed thereon, as compared to metal layers formed on polymer particles treated by conventional surface treatment processes. Such methods may be desirable since there is no limitation in the selection of materials that may be used for the polymer particles. Thus, various physical properties of the conductive particles required in interconnection structures may be effectively satisfied. In addition, in some embodiments of the invention, aggregation of the polymer particles during plating may be minimized.

According to some embodiments of the invention, polymer particles may be treated by a low-temperature plasma treatment. “Plasma” is often referred to as the “fourth state of matter,” whereby electrons from atoms, molecules or compounds in the plasma become stripped from nuclei of the respective atoms, molecules or compounds. Plasmas may consist of negatively charged electrons and positively charged ions and may be generated under a relatively high pressure or low pressure. Plasmas may be divided into two types: high-temperature plasmas (or thermal plasma) and low-temperature plasmas (or glow discharge). In high-temperature plasmas, the degree of ionization is relatively high, constituent elements are typically in a thermodynamic equilibrium state, and the average temperature may reach several tens of thousand degrees Celsius. In low-temperature plasmas, the degree of ionization may be insignificant (ion concentrations in a range of about 10⁻⁵ to about 10⁻⁶), constituent elements are not typically in a thermodynamic equilibrium state and the average temperature may be slightly higher than room temperature.

Differences between low-temperature plasmas and high-temperature plasmas are summarized in Table 1.

TABLE 1

| | High-temperature | Low-temperature |
|---|---|---|
| | plasma | plasma |
| Generation | Arc discharge | Glow or Corona |
| source | | discharge |
| Power supply | DC, AC, RF | DC, AC, RF, MW |
| | 10-10² V, 1-10⁵ A | 10²-10⁵ V, 10⁻⁴-10⁻¹ A |
| Temperature | Tₑ = Tᵢ = T_{g} = several | Tₑ = 10⁴-10⁵ K, |
| | 10³-10⁵ K | Tᵢ = T_{g} = several 10² K |
| | Local thermal equilibrium, | Non-equilibrium, |
| | High thermal capacity | Low thermal capacity |
| Plasma | 10²⁰-10²⁶/m³ | 10¹⁴-10¹⁹/m³ |
| density | | |
| Pressure | 10-10³ torr | 10⁻⁴-10 torr |
| | | (Glow discharge) |
| | | 10-10³ torr |
| | | (Corona discharge) |
| Uniformity | Average | Glow discharge: High, |
| | | Corona discharge: low |

Plasmas have been used in various applications, including synthesis of novel materials, processing and coating of thin films, surface processing of metals, semiconductor fields and bio-engineering fields. Plasmas are currently used in the fields of flat panel displays, such as plasma display panels (PDPs). Plasmas have also found use in the production of novel highly functional composite materials through surface hydrophobization, hydrophilization and coloration of polymer films or fibers or by imparting conductivity to polymer films or fibers.

Suitable reactors for the plasma treatment of polymer particles include static bed reactors, moving bed reactors and fluidized bed reactors. In fluidized bed reactors, particles may be supported by a drag force generated by a gas passing through the interstices of the particles above a specific rate and may behave like fluids. The gas may then mix with the polymer particles, while in continuous contact with the polymer particles, in the fluidized bed reactor. Accordingly, the use of fluidized bed reactors may be advantageous in terms of providing a relatively uniform surface treatment of the particles and providing suitable reaction efficiency.

Fluidized bed reactors typically include a reactor section, a gas injection section, a vacuum system and a plasma matching system. In some embodiments of the invention, the reactor section may be made of Pyrex and, in some embodiments, may have a diameter of approximately 30 mm and a height of approximately 600 mm. An RF (e.g., 13.56 MHz) generator may be connected to a lower electrode of the reactor through a match box. In some embodiments, the particles may be supported by a glass filter having a pore size of approximately 3 μm within the reactor. A plasma gas, e.g., argon, may be introduced into the reactor, in some embodiments, at a constant rate of about 14 sccm using a regulator. In some embodiments, the internal pressure of the reactor is fixed to 0.5 Torr. At this time, in some embodiments, the particles may be fluidized at a minimum rate of about 18.7 cm/s. The particles may then be plasma-treated (e.g., at a power of 100 W for 10 minutes). Thereafter, in some embodiments, the plasma-treated particles may be exposed to air (e.g., for 10 minutes) to introduce hydrophilic groups (e.g., peroxide and hydroxyl groups) onto the surface of the particles.

The surface hydrophilic groups may be quantitatively analyzed through reaction with 1,1-diphenyl-2-picrylhyrazyl (DPPH) using a UV-vis spectrophotometer. Specifically, the quantitative analysis may be conducted by treating the surface of 500 mg of the particles with an argon plasma, reacting the plasma-treated particles with air to form peroxide groups thereon, dipping the plasma-treated particles in a 1×10⁻⁴ mol/L DPPH solution, stirring the mixture at 70° C. for 24 hours to induce a reaction between the peroxide groups and the DPPH, and determining the unreacted amount of the DPPH by measuring the absorbance of the mixture using a UV-vis spectrophotometer at 520 nm.

There is no particular limitation to the type of polymer that may be included in the polymer particles. Exemplary suitable polymer particle materials include polyethylene, polypropylene, polyvinyl chloride, polystyrene for the, polytetrafluoroethylene, polyethylene terephthalate, polybutylene terephthalate, polyamide, polyimide, polysulfone, polyphenylene oxide, polyacetal, urethane resin, unsaturated polyester resin, (meth)acrylate resin, styrene-based resin, butadiene resin, epoxy resin, phenol resin, melamine resin and the like. The polymer materials may be used alone or in any suitable combination thereof.

In specific embodiments of the invention, the polymer particles may include styrene-based and/or (meth)acrylate resins. In some embodiments, the polymer particles include polymer resins containing at least one crosslinking polymerizable monomer. Exemplary crosslinking polymerizable monomers include allyl compounds, e.g., divinylbenzene, allyl (meth)acrylate, trially (iso)cyanate, and triallyl trimellitate, (poly)alkylene glycol di(meth)acrylate, e.g., (poly)ethylene glycol di(meth)acrylate and (poly)propylene glycol di(meth)acrylate, (poly)dimethylsiloxane di(meth)acrylate, (poly)dimethylsiloxane divinyl, (poly)urethane di(meth)acrylate, pentaerythritol tri(meth)acrylate, pentaerythritol di(meth)acrylate, trimethylolpropane tri(meth)acrylate, di(trimethylolpropane) tetra(meth)acrylate, tetramethylolpropane tetra(meth)acrylate, dipentaerythritol hexa(meth)acrylate, dipentaerythritol penta(meth)acrylate, glycerol tri(meth)acrylate, and the like. The crosslinking polymerizable monomers may be used alone or in any suitable combination thereof.

Monomers that may be used in combination with the crosslinking polymerizable monomers, include, but are not limited to, polymerizable unsaturated monomers that may be copolymerized with the crosslinking polymerizable monomers. Exemplary polymerizable unsaturated monomers include styrene-based monomers, e.g., styrene, α-methyl and ethyl vinylbenzene, methyl(meth)acrylate, ethyl(meth)acrylate, propyl(meth)acrylate, n-butyl(meth)acrylate, isobutyl(meth)acrylate, t-butyl(meth)acrylate, 2-ethylhexyl(meth)acrylate, n-octyl(meth)acrylate, lauryl(meth)acrylate, stearyl(meth)acrylate, ethyleneglycol (meth)acrylate, glycidyl(meth)acrylate, vinyl chloride, acrylic acid esters, acrylonitrile, vinyl acetate, vinyl propionate, vinyl butyrate, vinyl ether, allyl butyl ether, butadiene, isoprene and the like. The polymerizable unsaturated monomers may be used alone or in any suitable combination thereof.

The polymer particles used in the present invention can be prepared by any suitable method. Exemplary methods include suspension polymerization, dispersion polymerization, seeded polymerization and soap-free emulsion polymerization. In some embodiments, seeded polymerization may be used to prepare polymer particles having a relatively uniform particle diameter distribution.

In some embodiments of the invention, seeded polymerization may be carried out by the following procedure. First, polymer seed particles having a uniform particle diameter may be dispersed in an aqueous solution. To the dispersion may be added an aqueous emulsion of a crosslinking polymerizable unsaturated monomer in which an oil-soluble initiator is dissolved. This addition may swell the monomer inside the seed particles. Thereafter, the crosslinking polymerizable unsaturated monomer containing the seed particles may be polymerized to prepare polymer particles. Since the molecular weight of the polymer seed particles may substantially affect the phase separation and mechanical properties of the polymer particles prepared by the seeded polymerization, in some embodiments, the molecular weight is in a range of about 1,000 to about 30,000 g/mol, and in some embodiments, in a range of about 5,000 to about 20,000 g/mol. In some embodiments of the invention, the crosslinking polymerizable unsaturated monomer may be present in an amount in a range of about 10 to about 300 parts by weight, based on one part by weight of the swollen polymer seed particles.

The initiator used to prepare the polymer particles may be any suitable oil-soluble radical initiator. Specific examples include peroxide-based compounds, e.g., benzoyl peroxide, lauryl peroxide, t-butylperoxy-2-ethylhexanoate, t-butyl peroxyisobutyrate, dioctanoyl peroxide and didecanoyl peroxide, and azo compounds, e.g., 2,2′-azobisisobutyronitrile, 2,2′-azobis(2-methylbutyronitrile) and 2,2′-azobis(2,4-dimethylvaleronitrile), and the like. The initiators may be used alone or in any suitable combination thereof. In some embodiments, the initiator is used in an amount in a range of about 0.1 to about 20% by weight, based on the weight of the monomers.

During polymerization of the polymer particles, if necessary, a surfactant and a dispersion stabilizer may optionally be used to ensure the stability of latex. Common surfactants, such as anionic, cationic and non-ionic surfactants, may be used.

The dispersion stabilizer is a material that can be dissolved or dispersed in polymerization media Specific examples thereof include water-soluble polymers, e.g., gelatin, starch, methylcellulose, ethylcellulose, hydroxyethylcellulose, carboxymethylcellulose, polyvinylpyrrolidone, polyvinyl alkyl ether, polyvinyl alcohol, polyacrylic acid, polyacrylamide, polyethylene oxide and sodium polymethacrylate, barium sulfate, calcium sulfate, calcium carbonate, calcium phosphate, aluminum sulfate, talc, clay, diatomaceous earth, metal oxide powders, and the like. These materials may be used alone or in any combination thereof. In some embodiments, the dispersion stabilizer may be used in an amount sufficient to inhibit the settlement of the polymer particles formed during polymerization due to gravity and aggregation of the particles. In some embodiments, the dispersion stabilizer is used in an amount in a range of about 0.01 to about 15 parts by weight, based on 100 parts by weight of all the reactants.

In some embodiments of the present invention, the polymer particles have an average particle diameter in a range of about 1.0 μm to about 1,000 μm and, in some embodiments, a particle diameter distribution within about 90 to about 110% of the average particle diameter.

Furthermore, in some embodiments, the density of the hydrophilic groups introduced onto the surface of the polymer particles by hydrophilization may be in a range of about 1 to about 100 nmol/cm².

The conductive particles 1 may be prepared by forming conductive metal layers 12 on the surface of the polymer particles 11. Examplary metals that can be used to form the metal layers 12 include, but are not limited to, nickel (Ni), Ni—P, Ni—B, gold (Au), silver (Ag), copper (Cu), cobalt (Co), tin (Sn), indium (In), indium tin oxide (ITO), alloys containing these metals as main components, and multilayer composite metals that include different metal components. In some embodiments, the conductive metal layer is a metal bilayer 12 in which the surface of the polymer particles 11 is sequentially plated with nickel and gold. In some embodiments, other conductive metals, such as platinum (Pt) or silver (Ag), may be used instead of gold.

Exemplary methods of forming conductive metal layers on the base particles include, but are not limited to, coating by electroless plating, coating using metal powders, vacuum evaporation, ion plating and ion sputtering.

In some embodiments of the invention, preparation of the conductive particles by electroless plating is achieved by the following steps: sensitization, including surface hydrophilization of the base particles, etching and catalysis; electroless Ni plating and washing; and Au substitution plating.

Specifically, in some embodiments, the electroless plating may be carried out in accordance with the following procedure. First, the polymer particles selectively surface-hydrophilized with plasma may be dispersed in an aqueous solution and etched using a mixed solution of chromic acid and sulfuric acid to form “anchors” on the surface of the base particles. It is notable that pretreatment using a surfactant, which is a typical step in conventional fine powder plating processes, in some embodiments, may be excluded. That is, the selective surface hydrophilization of the polymer particles may eliminate the need for additional surface washing and degreasing of the polymer particles. Thereafter, the surface-treated base particles may be dipped in a solution of tin chloride and palladium chloride to catalyze and activate the particle surface. As a result, fine nuclei of the palladium catalyst may be formed on the surface of the base particles. Subsequently, a reduction reaction may be carried out, e.g., using sodium hypophosphite, sodium borohydride, dimethyl amine borane, hydrazine, and the like, to form relatively uniform palladium nuclei on the base particles. Although hydrophobic polymer particles containing no hydrophilic group may be plated, the surface hydrophilization of the polymer particles may minimize aggregation of the polymer particles. Therefore, in some embodiments, the plating yield of the polymer particles can be increased due to the improved dispersibility of the polymer particles.

The resulting polymer particles may be dispersed in an electroless nickel plating solution, after which the nickel salts may be reduced, e.g., using sodium hypophosphite, to form a nickel-plated layer on the polymer particles. The nickel-plated polymer particles may be added to an electroless gold plating solution having a gold concentration sufficient to induce a gold substitution plating reaction, thereby forming a gold-deposited layer on the outermost layer of the conductive particles.

In some embodiments of the invention, the conductive metal layer of the conductive particles 1 may include two or more metal layers formed on the polymer particles. In some embodiments, the metal layers each have a thickness in a range of about 10 to about 5,000 Å, and in some embodiments, the total thickness of the conductive metal layer is in a range of about 20 to about 10,000 Å. When each of the metal layers has a thickness of less than about 10 Å, it may be difficult to attain the desired conductivity. However, when each of the metal layers has a thickness exceeding about 5,000 Å, the deformability, elasticity and recoverability of the particles may not be satisfactory, and the particles may tend to aggregate when used in electrode packaging materials, making it difficult to provide the desirable conductivity.

Changes in the physical properties of the polymer particles before and after the plasma treatment may be represented by the relationship between applied compressive force and the amount of compressive deformation of the polymer particles, which is represented by the following equation:

$$F = \frac{( \frac{\sqrt{2}}{3} ) \cdot {S}^{\frac{3}{2}} \cdot E \cdot {R}^{\frac{1}{2}}}{1 - {σ}^{2}} \qquad ( 1 )$$

wherein F is a load value (kg) at x % compressive deformation, S is a compression displacement (mm) at x % compressive deformation, E is a compressive elastic modulus of the particles (kgf/mm²), R is a radius of the particles (mm), and σ is a Poisson's ratio of the particles.

Modification of Equation (1) gives the following equation:

$$\begin{matrix}K = \frac{E}{1 - {σ}^{2}} & ( 2 ) \\ wherein & \\ K = ( \frac{3}{\sqrt{2}} ) \cdot F \cdot {S}^{\frac{3}{2}} \cdot {R}^{\frac{1}{2}} & ( 3 )\end{matrix}$$

The K value may be measured using a micro-compression tester (e.g., MCT-W series, manufactured by Shimadzu Corporation Ltd., Japan). For example, the K value may be measured by fixing a single particle between a smooth upper pressure indenter (diameter: 50 μm) and a lower pressure plate, compressing the single particle at a compression speed of 0.2275 gf/sec and a maximum test load of 5 gf to obtain a load value and a compression displacement, and substituting the obtained values into the above equation.

The plating adhesiveness of the particles may be evaluated by comparing the contact resistance values obtained by compression of the plated conductive particles using a micro-compression tester under the same conditions.

The present invention will now be described in more detail with reference to the following examples. However, these examples are given for the purpose of illustration and are not to be construed as limiting the scope of the invention.

### EXAMPLES

### Example 1A

### Synthesis of Seed Particles

25 parts by weight of a styrene monomer, 5 parts by weight of 2,2′-azobis(2,4-dimethylvaleronitrile) as an initiator, 18.7 parts by weight of polyvinylpyrrolidone (molecular weight: 40,000 g/mol) as a dispersion stabilizer, and 200 parts by weight of methanol and 15 parts by weight of ultrapure water as reaction media were mixed together, quantified and fed into a reactor. Thereafter, the reaction mixture was subjected to polymerization under a nitrogen atmosphere at 60° C. for 24 hours to prepare polystyrene seed particles. The seed particles were completely washed with ultrapure water and methanol, and dried in a vacuum freeze dryer to obtain a powder. The seed particles were measured to have an average particle diameter of 1.13 μm, a CV value of 2.5%, and a weight average molecular weight of 12,500 g/mol.

### Example 1B

### Synthesis of Polymer Base Particles

2 parts by weight of the seed particles were homogeneously dispersed in 450 parts by weight of an aqueous sodium lauryl sulfate (SLS) solution (0.2 wt %). Separately, a monomer mixture consisting of 60 parts by weight of styrene and 10 parts by weight of divinylbenzene, in which 1 part by weight of benzoyl peroxide as an initiator was dissolved, was added to 300 parts by weight of an aqueous SLS solution (0.2 wt %). The resulting mixture was emulsified for 10 minutes using a homogenizer. The monomer emulsion was added to the seed particle dispersion to swell the monomers inside the seed particles at room temperature. After swelling, 500 parts by weight of an aqueous polyvinyl alcohol solution (5 wt %) having a saponification degree of about 88% was added thereto. The temperature of the reactor was raised to 80° C. and polymerization was performed to prepare crosslinked polymer particles. The crosslinked polymer particles were washed with ultrapure water and ethanol several times, and dried in vacuo at room temperature. The particle diameter of the polymer particles was determined using a Coulter counter to be 3.53 μm. The polymer particles were measured to have a CV value of 3.7%. Further, the 10% K value, compression recovery factor and compressive rupture deformation of the polymer particles were measured using a micro-compression tester, and the obtained results are shown in Table 2 below.

### Example 1C

### Plasma Treatment of Base Particles

The surface of the base particles was hydrophilized using a fluidized bed type reactor by the following procedure. First, the fluidized bed reactor was filled with 150 g of the base particles (H/D=6) and then kept under vacuum. Thereafter, argon was introduced into the reactor, and then the pressure of the reactor was fixed to 0.5 Torr. At this time, the base particles were fluidized at a rate of 18.7 cm/s. Next, the base particles were treated with plasma at a power of 100 W for 10 minutes and exposed to air for 10 minutes to introduce peroxide groups on the surface of the base particles. The concentration of the peroxide groups introduced was quantified through a reaction with DPPH. The results are shown in Table 2.

### Example 1D

### Preparation and Evaluation of Conductive Particles

The polymer particles were etched in an aqueous solution of chromic acid and sulfuric acid, dipped in a palladium chloride solution and reduced to form fine nuclei of the palladium on the surface of the base particles. Thereafter, electroless nickel plating and gold substitution plating were sequentially performed to obtain conductive particles in which nickel/gold conductive metal layers were formed on the base particles. The average particle diameter and CV value of the conductive particles were determined. Further, the 10% K value, compressive conductivity and compressive rupture deformation of the conductive particles were measured using a micro-compression tester, and the results are shown in Table 2 below.

### Example 2

Polymer particles were synthesized in the same manner as in Example 1, except that a monomer mixture consisting of 40 parts by weight of styrene, 20 parts by weight of n-butyl methacrylate and 40 parts by weight of 1,6-hexanediol diacrylate was used instead of the monomer mixture consisting of 60 parts by weight of styrene and 40 parts by weight of divinylbenzene. The polymer particles thus prepared were subjected to plasma treatment and electroless plating in the same manner as in Example 1 to prepare conductive particles. The physical properties of the conductive particles were evaluated in the same manner as in Example 1. The results are shown in Table 2.

### Example 3

Polymer particles were synthesized in the same manner as in Example 1, except that 100 parts by weight of divinylbenzene was used instead of the monomer mixture consisting of 60 parts by weight of styrene and 40 parts by weight of divinylbenzene. The polymer particles thus prepared were subjected to plasma treatment and electroless plating in the same manner as in Example 1 to prepare conductive particles. The properties of the conductive particles were evaluated in the same manner as in Example 1. The results are shown in Table 2.

### Comparative Example 1

Conductive particles were prepared using the same polymer particles as those prepared in Example 1 by electroless plating, except that no plasma treatment was performed. The aggregation of the conductive particles after plating was evaluated by measuring the CV value of the conductive particles using a Coulter counter. Further, the 10% K value, compressive conductivity and compressive rupture deformation of the conductive particles were measured using a micro-compression tester, and the results are shown in Table 2 below.

### Comparative Example 2

60 parts by weight of divinylbenzene, 30 parts by weight of styrene, 10 parts by weight of 2-hydroxy ethylmethacrylate and 2 parts by weight of benzoyl peroxide were added to 800 parts by weight of a 3% aqueous polyvinyl alcohol solution. A homogenizer was used to adjust the size of particles. Thereafter, the mixture was heated to 80° C. in a nitrogen stream with stirring to allow a reaction to proceed for 12 hours. The particles thus prepared were washed several times with ultrapure water and methanol, followed by size classification. The particles had a particle diameter of 3.62 μm and a CV value of 4.7. The compressive strength and recovery factor of the particles were measured, and the results are shown in Table 2. The particles were subjected to suspension polymerization to prepare polymer particles. Conductive particles were prepared using the polymer particles by electroless plating in the same manner as in Example 1, except that no plasma surface treatment was performed. The CV value, K value, compressive conductivity and compressive rupture deformation of the conductive particles were measured using a micro-compression tester, and the results are shown in Table 2 below.

TABLE 2

| | Before metal coating | | | | | | | | |
|---|---|---|---|---|---|---|---|---|---|
| | Before plasma | | After plasma | | | After metal coating | | | |
| | treatment | | treatment | | | | | 30% | |
| | 10% | Recovery | 10% | Recovery | | 10% | Recovery | compressive | |
| Example | K-value | factor | K-value | factor | CV | K-value | factor | resistance | CV |
| No. | (kgf/mm²) | (%) | (kgf/mm²) | (%) | value | (kgf/mm²) | (%) | (Ω) | value |
| Ex. 1 | 520 | 44 | 520 | 44 | 2.62 | 540 | 42 | 4.0 | 2.96 |
| Ex. 2 | 430 | 37 | 427 | 37 | 2.67 | 462 | 34 | 3.6 | 2.98 |
| Ex. 3 | 720 | 62 | 717 | 62 | 2.64 | 730 | 60 | 5.7 | 2.93 |
| Comp. Ex. 1 | 520 | 44 | — | — | 2.62 | 490 | 35 | 8.2 | 39.7 |
| Comp. Ex. 2 | 450 | 31 | — | — | 4.88 | 420 | 29 | 7.5 | 25.4 |

As can be seen from the results of Table 2, the conductive particles prepared through plasma treatment in Examples 1 to 3 displayed suitable physical properties. Further, the monodispersity of the conductive particles was maintained without substantial aggregation, even after plating, as indicated by the CV values of the conductive particles. In contrast, the conductive particles prepared without any selective hydrophilization by plasma treatment in Comparative Examples 1 and 2 showed a marked increase in CV value after plating, which indicates aggregation of the particles during plating. Particularly, the conductive particles prepared in Comparative Example 2, in which base particles was prepared by the copolymerization with 2-hydroxy ethylmethacrylate as a hydrophilic monomer to impart hydrophilicity to the base particles, showed considerable aggregation occurred during plating. Thus, that the plasma treatment of the base particles may substantially prevent aggregation during plating and the improvement of plating yield.

As apparent from the above description, according to some embodiments of the present invention, plasma treatment of polymer particles before electroless plating may selectively hydrophilize the surface of the polymer particles to form a plating layer having desirable adhesiveness and conductivity. Furthermore, the physical properties of the polymer particles may remain unchanged, even after plating, and electrical interconnection can be stably maintained. In addition, according to some embodiments of the present invention, aggregation of the polymer particles may be minimized during plating, and improvement in plating yield and processing optimization after plating may be simultaneously achieved. Furthermore, in some embodiments, there is no restriction in the choice of polymeric materials used for the polymer particles, and the polymer particles may not need to be treated with a surfactant prior to plating.

Although selected embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for preparing conductive particles, the method comprising:
hydrophilizing the surface of polymer particles by a low-temperature plasma treatment; and
coating the hydrophilized surface of the polymer particles with a conductive metal layer to form the conductive particles.

2. The method according to claim 1, wherein the low-temperature plasma treatment is performed in a fluidized bed reactor using a plasma gas comprising argon.

3. The method according to claim 1, further comprising
etching the hydrophilized polymer particles; and
dipping the etched polymer particles in a solution comprising tin chloride and palladium chloride.

4. The method according to claim 1, wherein the coating the polymer particles with a conductive metal layer is performed by a coating process selected from the group consisting of coating by electroless plating, coating using a metal powder, vacuum evaporation, ion plating and ion sputtering.

5. The method according to claim 1, wherein the hydrophilization introduces one or more of a peroxide and a hydroxyl group to the surface of the polymer particles.

6. The method according to claim 1, wherein the hydrophilization of the surface of the polymer particles introduces hydrophilic groups to the surface of the polymer particles at a density in a range of about 1 to about 100 nmol/cm².

7. The method according to claim 1, wherein the polymer particles have an average particle diameter in a range of about 1.0 μm to about 1,000 μm and a particle diameter distribution within about 90 to about 110% of the average particle diameter.

8. The method according to claim 1, wherein the conductive metal layer comprises two or more metal layers, wherein each metal layer is independently selected from the group consisting of Ni, Ni—P, Ni—B, Au, Ag, Ti and Cu layers.

9. The method according to claim 8, wherein each of the metal layers has a thickness in a range of about 10 to about 5,000 Å.

10. The method according to claim 8, wherein the total thickness of the conductive metal layer is in a range of about 20 to about 10,000 Å.

11. A conductive particle prepared by the method according to claim 1.
